(19) United States
(12) Patent Application Publication
(10) Pub. No.: US 2007/0299933 A1
(43) Pub. Date: Dec. 27, 2007

(54) Target Advertisement System in Community of Network and Method Thereof

(75) Inventor: Sun-Mi Moon, Seoul (KR)

Correspondence Address: MARGER JOHNSON & MCCOLLOM, P.C., 210 SW MORRISON STREET, SUITE 400, PORTLAND, OR, 97204, US

(73) Assignee: NHN CORPORATION, Seongnam si, Kyunggi-do (KR)

(21) Appl. No.: 11/813,420

(22) PCT Filed: Dec. 20, 2005
(86) PCT No.: PCT/KR05/04393

§ 371 Date: Jul. 5, 2007

(30) Foreign Application Priority Data
Jan. 5, 2005 (KR) 10-2005-0000763

(51) Int. Cl. G06Q 30/00; G06F 17/30

(52) U.S. Cl. 709/218; 707/10

(57) ABSTRACT

Disclosed is a target advertisement system and method of implementing the target advertisement system through network communities. Target advertisement is performed by using advertisement skin images in the community provided through the network. When a user accesses a community page using advertisement skin images through the network, the user's characteristic information is determined, and skin configuration components of the advertisement skin image displayed on the community page are dynamically changed based on the user's characteristic information. The community page based on the skin image having skin configuration components changed according to the user's characteristic information is displayed on a user terminal. To increase advertisement effects, when the first user uses and posts the advertisement skin image in the first user's community page and a second user accesses the community and receives the advertisement skin image, a predetermined compensation is provided to the first user.

### TECHNICAL FIELD

The present invention relates to a target advertisement system and method. More specifically, the present invention relates to a target advertisement system and method in a network community.

### BACKGROUND ART

In general, advertisements have been provided through media such as TV sets, newspapers, and magazines, and as the distribution of the Internet has been substantially increased recently, people all over the world have come to share various pieces of information through this medium. Advertisements using the Internet have has also been substantially increased according to this trend.

In addition, as advertising on the Internet has increased, various techniques for providing advertisements that satisfy users' interests and promote their purchases have been developed.

As to prior art, Korean Publication No. 2001-96877 discloses “Target marketing method and system using Internet IP address database” which stores user information such as users' age, job, sex, and personality in an IP address database corresponding to the users' IP addresses, extracts IP addresses of users who access the web server, and provides suitable advertisements or contents to the users according to the user information corresponding to the extracted IP address.

As to another prior art, Korean Publication No. 2002-29270 discloses “Advertisement system and method using skin image attached on the window of user terminal” which dynamically performs target marketing on the network by using an advertisement skin image. In particular, the prior art controls to download a skin image controller to the user terminal when the user accesses the server's homepage, and it provides advertisement skin image information to the terminal's window based on the user analysis when the user selects the advertisement menu. The skin image controller displays the advertisement skin image information to the user's browser at regular time intervals.

Various target advertisements based on the users' characteristics have been conventionally provided, but they have less advertisement ripple effects since the advertisements are provided only to users who have accessed the corresponding server.

Further, compensation has been provided to users for the purpose of improving advertisement effects, but they have been provided only depending on the time when the corresponding users have accessed the advertisements, and hence, methods for the users to spread the advertisements by compensating the users in more various ways are required.

### DISCLOSURE

### Technical Problem

It is an advantage of the present invention to improve advertisement effects by providing the corresponding advertisements to more users when the advertisements are provided through the network.

It is another advantage of the present invention to perform target advertising through network communities and provide efficient target advertisements by applying trends of corresponding advertisement users.

It is still another advantage of the present invention to provide efficient compensation to the corresponding advertisement users in the network communities and thereby provide the corresponding advertisements to more users.

### Technical Solution

In one aspect of the present invention, a target advertisement method of a system for performing advertisement in a community provided through a network includes a) the system determining a user's characteristic information when the user accesses a community page that uses an advertisement skin image through the network; b) the system dynamically changing skin image components of the advertisement skin image displayed on the community page based on the user's characteristic information; and c) the system transmitting the community page that is based on the skin image with skin configuration components changed according to the user's characteristic information to the user's terminal so that the terminal may display the community page.

In another aspect of the present invention, a system for performing target advertisement on a community page provided through a network includes a user database for storing users' characteristic information for respective users; a first community database for storing community information including skin images for the users' communities; a second community database for storing community information including advertisement skin images for sponsors' communities; an advertisement database for storing skin configuration components for respective advertisement skin images; a community manager for selectively providing a community page configured by an advertisement skin image to terminals of users accessed through the network so that the terminals may display the community page; and an advertisement selector for selecting predetermined skin configuration components from the advertisement database according to the characteristic information of the users receiving the community page, wherein the community manager applies the skin configuration components selected by the advertisement selector to the advertisement skin image to provide a community page configured by the advertisement skin image to the user terminal.

### DESCRIPTION OF DRAWINGS

FIG. 1 shows a block diagram of a target advertisement system according to an embodiment of the present invention.

FIG. 2 to FIG. 4 show block diagrams of servers shown in FIG. 1.

FIG. 5 shows a flowchart for a target advertisement providing process according to an embodiment of the present invention.

FIG. 6 shows a flowchart for a compensation process according to an embodiment of the present invention.

### BEST MODE

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive. To clarify the present invention, parts which are not described in the specification are omitted, and parts for which similar descriptions are provided have the same reference numerals.

In the embodiment of the present invention, target advertisements are performed based on the characteristics of network users, and in particular, the target advertisements are performed through skin images configuring the users' communities.

Recently, various types of communities (blog homepages, personal communities such as mini homepages, and shared communities such as cafes or clubs) have been activated, and various skin images forming corresponding communities have been provided so as to activate the communities. In particular, a community system generates various skin images to the users so that they may select the skin images or they may generate their own skin images and use the same as the skin images of corresponding communities, and they may show their personalities in the personal communities such as mini homepages and blogs. In general, when the user logs in to the community system while a predetermined skin image is selected, skin images stored corresponding to the corresponding user's ID are used to provide the user's community pages to the user terminal. Therefore, the community pages (including the homepage and blog initial pages) configured with the skin images selected by the user are displayed to the user terminal.

In the embodiment of the present invention, the target advertisement is performed by using the skin images provided by the community on the network. For this, various advertisement skin images are provided, in particular, by dynamically varying the various advertisement skin images according to the characteristics of the users having accessed the advertisement skin images. For example, text, background color, background images, or multimedia data configuring the skin images are varied according to the users' characteristic information. In this instance, the components of configuring the skin images, such as text, background color, background images, or multimedia data will be referred to as “skin configuration components.” The users' characteristic information represents information for indicating what characteristics the users have, for example, sex, ages, jobs, residential areas, and hobbies.

Also in the embodiment of the present invention, while the target advertisement is performed by using the skin image, the user can use the corresponding advertisement skin image as the skin image of the user's community. In order to increase the advertisement effects, when a first user posts a predetermined received advertisement skin image on the first user's personal community page and a second user accesses the page to receive the advertisement skin image, predetermined compensation is provided to the first user based on the number of second users.

The target advertisement system and method through the network according to the embodiment of the present invention will be further described.

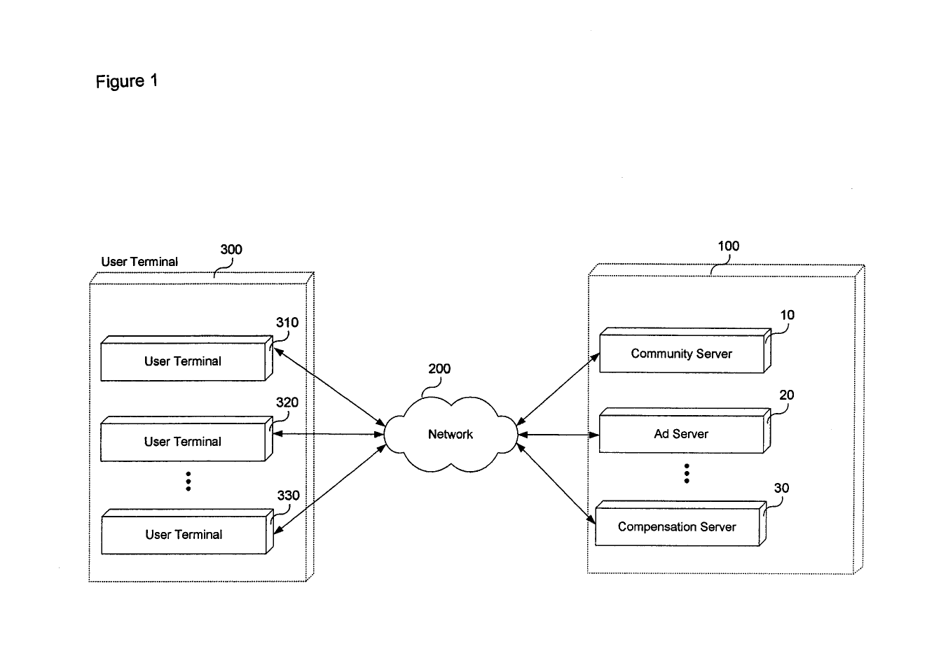

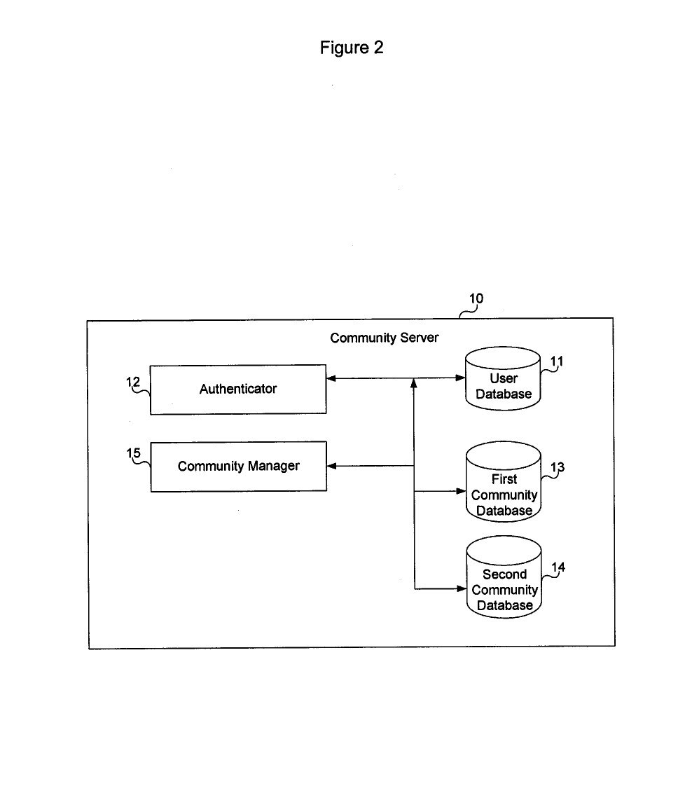

FIG. 1 shows a block diagram of a target advertisement system according to an embodiment of the present invention. FIG. 2 to FIG. 4 show block diagrams of servers shown in FIG. 1.

The target advertisement system for providing advertisements to the user through the network 200 including the Internet is connected to a plurality of user terminals 310, 320, 330, . . . , (referred to as 300 for ease of description) through the network 200 (including telephone, Internet, and wireless communication networks) as shown in FIG. 1.

The user terminal 300 is a communication device accessible to the target advertisement system 100 through the network 200, and includes a cable telephone, a mobile terminal, a computer, and an Internet TV. Therefore, the user can conveniently and quickly access the target advertisement system 100 by using PC communication, Internet, wireless Internet, and telephone networks.

The target advertisement system 100 connected to the user terminal 300 includes a community server 10, an advertisement server 20, and a compensation server 30.

The community server 10 provides a community service to the users through the network 200. For example, the community service includes personal community services including homepages, mini homepages, and blogs, and shared community services including cafes and clubs managed by many users. The case of providing the personal community service will be exemplified.

As shown in FIG. 2, the community server 10 includes a user database 11 for storing information on users who are registered to use the communities of the system (e.g., to open personal communities (homepages or blogs) through the system); an authenticator 12 for authenticating the users; a first community database 13 for storing information on the communities opened by the respective users; a second community database 14 for storing information on advertisement communities opened for respective sponsors; and a community manager 15 for performing functions for opening and processing communities.

The user database 11 stores information on the users who have opened personal communities (personnel information including IDs, passwords, names, residential codes, sex, ages, and occupations, characteristic information, and tendency information.)

The first community database 13 stores community configuration information for respective users' communities, and contents provided by the communities. The community configuration information includes various types of components for configuring personal communities by the users and it includes skin images selected by the user in the embodiment of the present invention, and it may store the number of users who have visited the corresponding communities.

The second community database 14 stores community configuration information for respective sponsors' advertisement communities, and contents provided by the communities. The community configuration information includes advertisement skin images provided by the corresponding sponsors.

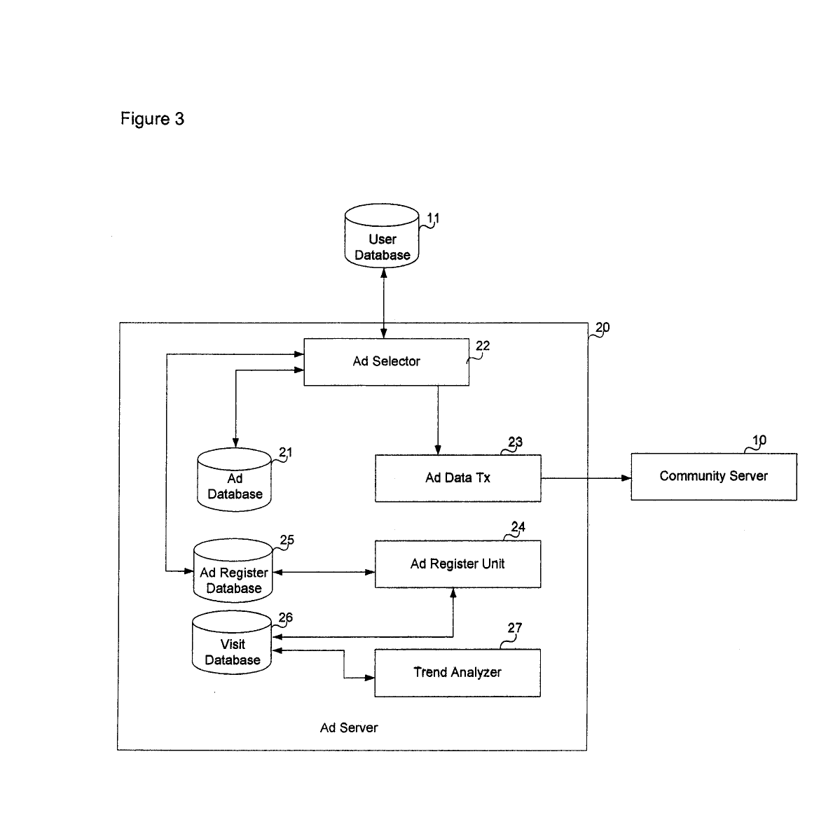

As shown in FIG. 3, the advertisement server 20 for providing advertisements to users accessing the community server 10 through the network in cooperation with the community server 10 includes an advertisement database 21 for storing a plurality of skin configuration components for configuring advertisement skin images; an advertisement selector 22 for selecting a skin configuration component based on the user's characteristic information; and an advertisement data transmitter 23 for transmitting the selected skin configuration component to the community server 10 and controlling the skin configuration component to be displayed on the community page where the user is located.

The advertisement database 21 stores a plurality of advertisement data to be provided by the system. In particular, in the embodiment of the present invention, the skin configuration components configuring respective advertisement skin images are stored corresponding to the combination of respective items configuring the respective users' characteristic information so that the advertisement skin images forming the background of the advertisement community may be varied according to the user characteristics. That is, skin configuration components configuring a predetermined advertisement skin image are stored corresponding to at least one item of the users' sex, ages, occupations, and hobbies, and the advertisement selector 22 can easily select corresponding skin configuration components based on the user characteristic information.

In addition to this, the advertisement server 20 further includes an advertisement register unit 24 for providing the advertisement skin image to the user's community page to thus register the advertisement when the user desires to receive the corresponding advertisement skin image in a predetermined community; and an advertisement register database 25 for storing information on the advertisements provided to the respective community pages.

Also, the advertisement server 20 may further include a visit database 26 for storing characteristic information on the accessed users for the respective advertisement communities, and a trend analyzer 27 for analyzing what users with characteristics for respective advertisement communities have accessed based on the characteristic information. The trend analyzer 27 identifies the users who generally visit the advertisement community with respect to their age, occupation, or hobbies, and it analyzes such trends which are then reflected to the advertisement skin image.

The compensation server 30 posts the advertisement skin image provided by the community to the community of the compensation server 30 to thus compensate the users who have provided the advertisement skin image to other users.

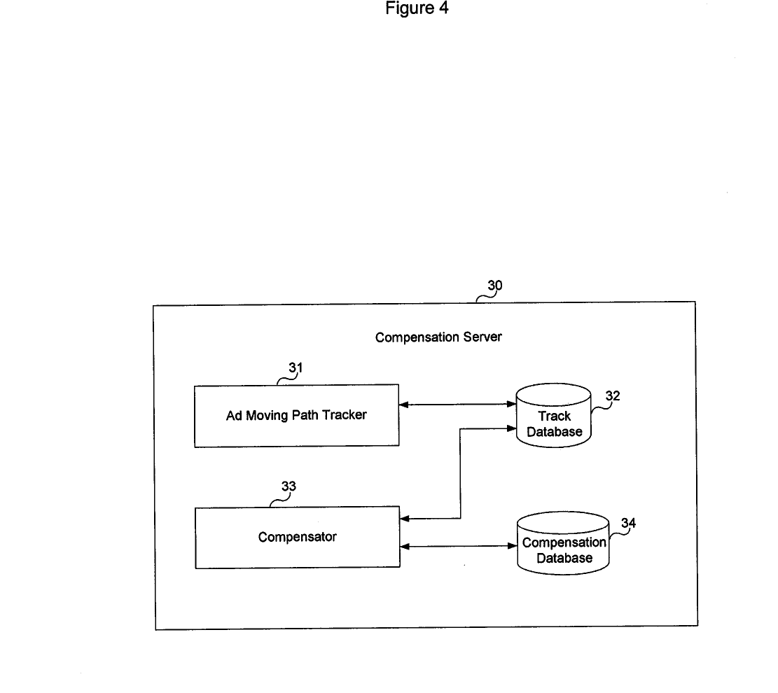

As shown in FIG. 4, the compensation server 30 includes an advertisement moving path tracker 31 for tracking a moving path of the advertisement skin image; a track database 32 for storing moving paths for respective advertisement skin images; a compensator 33 for compensating usage of advertisement skin images; and a compensation database 34 for storing a compensation history for respective users.

In this instance, the moving path of the advertisement skin image represents the path on which the advertisement skin image moves from a first user's community page to a second user's community page, and the same can be used as information for indicating IDs of a user community in which an advertisement skin image is posted or user IDs. Therefore, the track database 32 can exemplarily store information on the path on which the advertisement skin image is moved to respective communities by the users, such as an ID of a first community in which an advertisement skin image is initially posted, an ID of a corresponding first user, an ID of at least one second community to which the advertisement skin image is moved, or an ID of corresponding second users.

In the target advertisement system according to the embodiment of the present invention, the respective servers 10 to 30 are classified according to their functions, and they are variable without being restricted to the classification. For example, the databases of the system can be included in a single database server.

Further, the configuration components of the respective servers are optional and can be realized as individual servers to process corresponding functions. Also, the databases are not restricted to the above-described classification.

In addition, the community server is exemplarily realized to be included in the target advertisement system, and it is also possible to realize the community server separate from the target advertisement system so that the advertisements can be provided to the community in cooperation with the target advertisement system.

An operation of the target advertisement system according to the embodiment of the present invention will be described based on the above-noted configuration.

A method for performing target advertisement to users accessed to the community will now be described.

The respective users register themselves as members to the community server 10, and selectively receive their personal community pages from the community server 10. The users having received the personal community page can configure a personal community by using various items provided by the community server 10. In particular, they can decorate their community by using a predetermined skin image generated by them or skin imaged provided by the community server 10.

Also, the advertisement server 20 receives advertisement requests from sponsors who desire to advertise predetermined goods (tangible or intangible goods) and separately generates advertisement skin images of the goods of the corresponding sponsors, or directly receives advertisement skin images of the goods from the sponsor and transmits the advertisement skin image to the community server 10 to request the opening of the sponsor's community. Accordingly, advertisement communities configured by corresponding advertisement skin images can be opened for the respective sponsors in the community server 10.

Target advertisement is performed as follows when the communities are formed for the respective users and the communities are formed for the respective sponsors as described above.

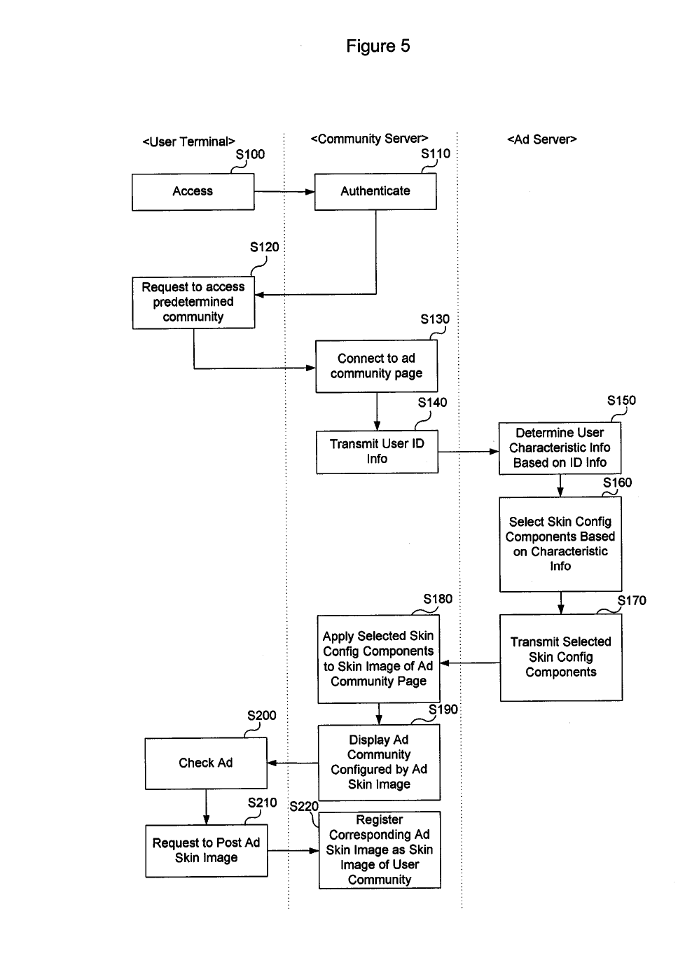

FIG. 5 shows a flowchart for a target advertisement providing process according to an embodiment of the present invention.

As shown in FIG. 5, when a predetermined user is accessed through a terminal 300, it is determined by the authenticator 12 of the community server 10 whether the user is available for the service provided by the system 100, and when the user is authenticated to use the service, the community manager 15 connects the user to another user's personal community page, a predetermined sponsor's advertisement community page, or the user's personal community page according to the user's request in steps S100 to S130. It will be assumed in this instance that the user is connected to the predetermined sponsor's advertisement community page.

The community manager 15 of the community server 10 transmits the user's identification information to the advertisement server 20 in step S140 when the user requests a connection to a predetermined advertisement community page. The advertisement selector 22 of the advertisement server 20 searches the user database 11 to check the user's characteristic information based on the user's identification information. For example, the advertisement selector 22 determines at least one of the user's sex, age, occupation, and hobbies in step S150.

Next, the advertisement selector 22 searches the advertisement database 21 based on the user's characteristic information to select skin configuration components for configuring the advertisement skin image corresponding to the advertisement community. That is, the advertisement selector 22 selects skin configuration components appropriate for the user's characteristic information and transmits the skin configuration components to the community manager 15 in steps S160 and S170.

The community manager 15 applies the modified skin configuration components to the advertisement skin image of the advertisement community accessible by the user, provided by the second community database 14, and displays applied results in step S180. Therefore, when the user accesses a predetermined advertisement community page, the advertisement skin image of the corresponding advertisement community page is displayed by the user terminal 300, and predetermined skin configuration components selected according to the user's characteristic information are displayed thereon in step S190. For example, in the case of providing an advertisement skin image, when the user accesses the advertisement community of Samsung Electronics, the advertisement skin image of Samsung Electronics is displayed, and predetermined text, background color, predetermined advertisement goods, or multimedia data displayed on the advertisement skin image are selectively varied. That is, an advertisement corresponding to middle-sized and small-sized televisions of Samsung Electronics is selected and displayed when the user is a teenager, an advertisement corresponding to middle-sized televisions is selected and displayed when the user is in his twenties, and an advertisement corresponding to digital televisions from among large-sized televisions is selected and displayed when the user is in his thirties. In addition, it is possible to change advertisement captions displayed according to the user's sex or occupation while displaying the advertisement of the predetermined goods depending on the age. Therefore, the user's interest in the corresponding goods is increased by dynamically changing the advertisement skin image according to the accessed user's characteristic information while predetermined goods are advertised on the predetermined advertisement community page.

Further, trends of users who visit advertisement communities are easily known by performing predetermined target advertisement according to the users' characteristic information in the above-described advertisement community. That is, the trend analyzer 27 of the advertisement server 20 stores characteristic information on the accessed users for the respective advertisement communities in the visit database 26, and periodically analyzes the trends based on the characteristic information. In this instance, the trends indicate the users' access to the respective advertisement communities with respect to the users' characteristics. The trend analyzer 27 can change the advertisement skin image of the corresponding advertisement community based on the trends. When the advertisement skin image is changed, the advertisement server 20 transmits the changed advertisement skin image to the community server 10, and when a predetermined user is accessed to the advertisement community, the community server 10 provides the user with an advertisement community page including the changed advertisement skin image. Therefore, the advertisement skin image of the advertisement community is changed at regular temporal intervals by applying trends, and the skin configuration components of the advertisement skin image to which the trends are applied are selectively changed according to the characteristic information of the user having accessed the corresponding advertisement community so that the optimized target advertisement more appropriate for the user characteristics is performed.

The user having received a predetermined advertisement through the above-noted process can use the corresponding advertisement skin image as a skin image of his personal community page. For example, when the user clicks a corresponding advertisement skin image at least twice or requests to post the advertisement skin image through an additional menu, the community manager 15 stores the corresponding advertisement skin image corresponding to the user community of the first community database 13 so that the community having the advertisement skin image as a background may be displayed when the user accesses the community in steps S200 and S210.

The above-described target advertisement process has exemplified the case in which the user has accessed the community of a predetermined sponsor, and in addition, the target advertisement can be performed when the user accesses a community of another user who requested to post a predetermined sponsor's advertisement skin image in the community page. That is, when the first user uses a predetermined advertisement skin image for his community and the second user accesses the first user's community, the advertisement server 20 selects skin configuration components configuring the advertisement skin image based on the second user's characteristic information, and the community server 10 displays the advertisement skin image configured by the selected skin configuration components to the first user's community so that the second user may view the advertisement skin image having dynamically changed components according to the second user's characteristic information.

Therefore, the advertisement skin image is dynamically changed and displayed according to the characteristic information of the user accessing the community to thus provide advertisements that fit the user characteristics and improve advertisement effects in the community for providing advertisement skin images (including sponsors' communities and general users' communities.) A compensation process generated when the second user having checked the advertisement skin image from the first user's community requests to post an advertisement skin image in the second user's community will now be described.

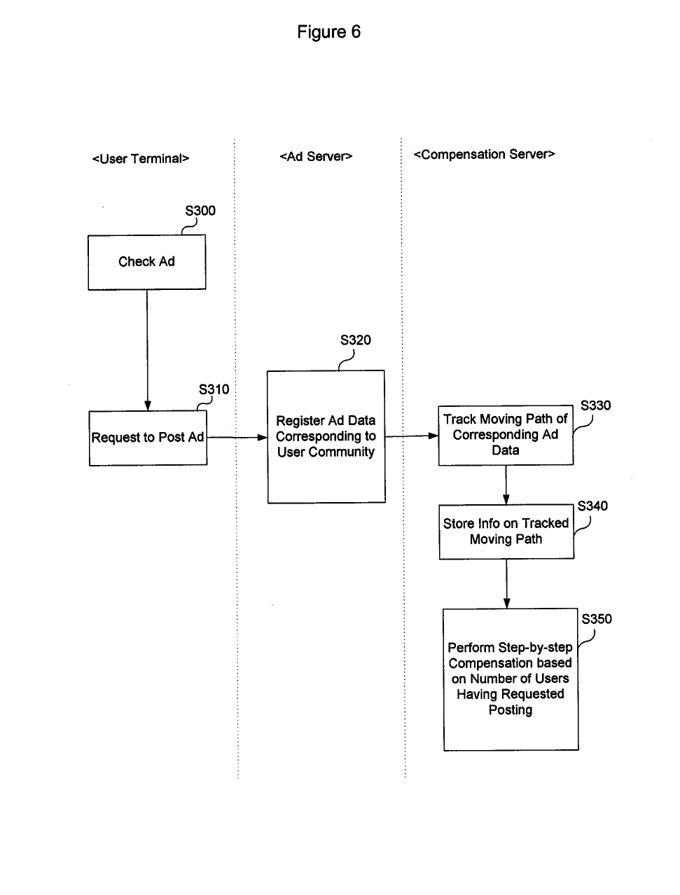

FIG. 6 shows a flowchart for a compensation process according to an embodiment of the present invention.

When the second user having checked a predetermined advertisement skin image in the first user's community requests to post the advertisement skin image to the second user's personal community in steps S300 and S310, the advertisement register unit 24 of the advertisement server 20 stores information (e.g., an advertisement ID) on the advertisement skin image to which the posting process is requested in the advertisement register database 25 in correspondence to the second user's ID or the second user's personal community ID. The community manager 15 of the community server 10 stores the advertisement skin image corresponding to the second user's community of the first community database 13 so that the community having the advertisement skin image as a background may be displayed when the second user accesses the community. In this instance, the user terminal can be connected to the second user's personal community page according to the second user's advertisement posting request.

The advertisement moving path tracker 31 of the compensation server 30 tracks the moving path of the advertisement skin image and records the moved advertisement skin image corresponding to the first user ID, and the number of second users having posted corresponding advertisements for the respective advertisement skin images in the track database 32 in steps S330 and S340.

The steps S330 and S340 for moving and posting the advertisement skin image and tracking the corresponding moving path are performed according to the users' requests of posting advertisement skin images. An advertisement skin image (received from the first user's personal community page) is provided from the second user's personal community page, and when the third user requests to post the advertisement skin image in the third user's personal community, the processes for moving and posting the advertisement skin image and tracking the moving path are performed as shown in the steps S330 and S340. That is, the advertisement skin images are moved step by step between the community in which the advertisement skin image is posted and communities of users who accessed the community and requested to post the advertisement skin image. Therefore, since the advertisement skin image can be moved step by step to a plurality of communities and be posted therein according to the users' requests, the advertisement skin image can be provided to many users and advertisement propagation effects are substantially increased.

As the processes for moving and posting the advertisement skin image and tracking the corresponding moving path are performed, the track database 32 records information on the first user having initially posted an advertisement skin image and information on the 2^{nd}, 3^{rd}, 4^{th}, . . . and n^{th} users having posted the advertisement skin images.

The compensation processor 33 compensates for the users' advertisement propagation based on the moving path information stored in the track database 32 at regular intervals, for each predefined time frame, or at a predetermined time requested by the users. That is, the compensation process is performed based on the number of other users who requested to post an advertisement in the users' community pages for the respective users, or the number of visitors who accessed their community pages and checked the advertisement skin image, and in this instance, predetermined compensation is provided to the original user who initially posted the corresponding advertisement skin image. For example, when a single advertisement skin image is moved step by step to the second and third users' personal community pages from the first user's personal community page, and is then posted therein, a predetermined compensation is produced and part of the compensation is provided to the second user according to the number of third users, and the rest of the compensation is provided to the first user in step S350. In this instance, compensation means, such as compensation money, is provided according to posting of advertisement skin images include valuable means for using predetermined services such as cyber money or cash, service using means such as periods for using the images, and other types of compensation means provided in various formats on the network.

According to the above-described compensation process, the users further request to post predetermined advertisement skin images on their personal community pages, thereby improving advertisement effects.

In the above-described embodiment of the present invention, predetermined skin configuration components are selected to dynamically change the advertisement skin image according to the combination of respective items configuring the users' characteristic information, and in addition to this, it is possible for predetermined advertisement communities to have corresponding advertisement skin images for the combinations of respective items that configure the users' characteristic information, select a predetermined advertisement skin image according to the accessed user's characteristic information, and provide the selected advertisement skin image.

Further, the above-described method is realizable in a program that is recorded on a computer-readable recording medium. The recording medium may include any types of recording devices for storing data that is readable by the computer, for example, CD-ROMs, magnetic tapes, and floppy disks as well as carrier wave type formats (e.g., Internet transmission.)

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

### INDUSTRIAL APPLICABILITY

According to the embodiment of the present invention, predetermined advertisements can be performed through communities on a network, and in particular, predetermined goods are advertised through skin images on a predetermined advertisement community page and advertisement skin images are dynamically changed according to the accessing user's characteristic information so that appropriate advertisements are provided to the user and the user becomes more excited with the corresponding goods.

Also, predetermined target advertisements are performed according to the users' characteristic information in the advertisement communities so that the trends of users visiting corresponding advertisement communities may be easily acquired. Therefore, the advertisement skin images are changed based on the trends of users accessing the advertisement community so that the optimized advertisement may be provided depending on the trends.

Further, since the compensation is performed according to the users' posting of advertisement skin images, usage of advertisements by the community users is increased and advertisement propagation effects are substantially improved.

1. A target advertisement method of a system for performing advertisement in a community provided through a network, the target advertisement method comprising:
a) the system determining a user's characteristic information when the user accesses a community page that uses an advertisement skin image through the network;
b) the system dynamically changing skin image components of the advertisement skin image displayed on the community page based on the user's characteristic information; and
c) the system transmitting the community page that is based on the skin image with skin configuration components changed according to the user's characteristic information to the user's terminal so that the terminal may display the community page.

2. The target advertisement method of claim 1, wherein the skin configuration components includes at least one of text, background color, background picture, and multimedia data,
the user's characteristic information includes at least one of sex, age, occupation, residential area, and hobbies, and
b) comprises changing at least one of the skin configuration components based on at least one part of the user's characteristic information.

3. The target advertisement method of claim 1, further comprising d) registering provision of an advertisement skin image on the community page of the user when the user requests to post the advertisement skin image in the user's community page, and
d) is performed step by step between the users' communities according to the requests of the users having accessed the community displaying the advertisement skin image.

4. The target advertisement method of claim 3, further comprising compensating the first user for propagation of the advertisement skin image when the predetermined advertisement skin image posted in the first user's community page is posted in the second user's community page according to the request by the second user.

5. The target advertisement method of claim 4, wherein the method comprises:
tracking, step by step, the moving path on which the advertisement skin image moves from the first user's community page to the second user's community page;
storing the number of second users requesting to post the advertisement skin image according to the tracking of the moving path; and
compensating the first users having posted the advertisement skin image based on the number of second users having requested to post the advertisement skin image.

6. The target advertisement method of claim 3, further comprising compensating for the propagation of the advertisement skin image based on the number of second users having accessed the first user's community page using the advertisement skin image.

7. The target advertisement method of claim 5 or 6, wherein the compensation process comprises: producing compensation money based on the number of second users, providing part of the compensation money to the first user, and providing the rest part of the compensation money to the original user having used the advertisement skin image before the first user.

8. The target advertisement method of claim 1 or 2, further comprising:
storing characteristic information on the users having accessed the community page using the advertisement skin image;
analyzing trends of users having accessed the community page based on the stored information at an established time; and
changing the advertisement skin image of the community page based on the trends, and
d) comprising selectively changing configuration components of the changed advertisement skin image based on the accessing user's characteristic information.

9. In a system for performing target advertisement on a community page provided through a network, the target advertisement system comprising:
a user database for storing users' characteristic information for respective users;
a first community database for storing community information including skin images for the users' communities;
a second community database for storing community information including advertisement skin images for sponsors' communities;
an advertisement database for storing skin configuration components for respective advertisement skin images;
a community manager for selectively providing a community page configured by an advertisement skin image to terminal of users accessed through the network so that the terminals may display the community page; and
an advertisement selector for selecting predetermined skin configuration components from the advertisement database according to the characteristic information of the users receiving the community page,
wherein the community manager applies the skin configuration components selected by the advertisement selector to the advertisement skin image to provide a community page configured by the advertisement skin image to the user terminal.

10. The target advertisement system of claim 9, further comprising:
an advertisement register unit for providing an advertisement skin image to the user's community page when the user having received the community requests to post the advertisement skin image in the user's community page;
a moving path tracker for tracking the moving path of the advertisement skin image according to the advertisement posting request;
a track database for storing moving path information for the respective skin images;
a compensator for compensating the usage of advertisement skin images based on the moving path information of the advertisement skin images stored in the track database; and
a compensation database for storing compensation histories for the respective users.

11. The target advertisement system of claim 10, wherein the moving path represents a path on which an advertisement skin image moves from a user's community page to another user's community page, and includes an ID of a first community in which the advertisement skin image is posted, an ID of the corresponding first user, an ID of at least one second community to which the advertisement data are moved, IDs of corresponding second users, and the number of second users, and
the compensator compensates the first user according to the number of second users having requested the posting of the advertisement.
